(19) United States
(12) Patent Application Publication
(10) Pub. No.: US 2024/0335786 A1
(43) Pub. Date: Oct. 10, 2024

(54) PROCESS FOR SEPARATING CARBON DIOXIDE FROM A RAW HYDROGEN PRODUCT

(71) Applicant: L'Air Liquide, Société Anonyme pour l'Etude et l'Exploitation des Procédés Georges Claude, Paris (FR)

(72) Inventors: Sophia SCHMIDT, Frankfurt am Main (DE); Matthias LINICUS, Eppstein (DE)

(73) Assignee: L'Air Liquide, Société Anonyme pour l'Etude et l'Exploitation des Procédés Georges Claude, Paris (FR)

(21) Appl. No.: 18/627,263

(22) Filed: Apr. 4, 2024

(30) Foreign Application Priority Data
Apr. 4, 2023 (EP) 23166529.0

(51) Int. Cl. B01D 53/14; B01D 17/04

(52) U.S. Cl. CPC B01D 53/1425; B01D 17/042; B01D 53/1418; B01D 53/1475; B01D 53/1493; B01D 2252/2021; B01D 2256/16; B01D 2257/504

(57) ABSTRACT

The invention relates to a process for separating carbon dioxide from a raw hydrogen product stream to produce a hydrogen product stream and a carbon dioxide product stream. The process includes the absorption of carbon dioxide in an absorption stage in an absorption medium and subsequent desorption of the carbon dioxide from the laden absorption medium in a plurality of decompression stages. According to the invention carbon dioxide substreams withdrawn from the decompression stages are combined into a carbon dioxide total stream and compressed in a plurality of serially arranged compression stages. Each compression stage having a suction pressure value is assigned at least one decompression stage with a corresponding desorption pressure value and the number of decompression stages corresponds at least to the number of compression stages.

### CROSS REFERENCE TO RELATED APPLICATIONS

This application claims the benefit of priority under 35 U.S.C. § 119 (a) and (b) to European Patent Application No. 23166529.0, filed Apr. 4, 2023, the entire contents of which are incorporated herein by reference.

### BACKGROUND

### Field of the Invention

The invention relates to a process for separating carbon dioxide (CO₂) from a raw hydrogen product stream to obtain a hydrogen product stream and a carbon dioxide product stream.

### Prior Art

EP 4 000 713 and EP 4 000 714 disclose a process for removing carbon dioxide from synthesis gas using a hygroscopic, physical absorption medium. The process is characterized in that carbon dioxide is removed in a physical absorption step at elevated pressure and carbon dioxide-laden absorption medium is treated in a plurality of serially arranged flash stages. In a flash stage arranged downstream of the first flash stage or a plurality of flash stages arranged downstream of the first flash stage carbon dioxide is removed from the laden absorption medium by pressure reduction. The carbon dioxide desorbed from the laden absorption medium may then either be sequestered (carbon capture and storage, CCS) or sent to a further use (carbon capture and utilization, CCU).

The thus-obtainable carbon dioxide stream must typically be freed of absorption medium residues, optionally dried, and recompressed to be suitable for the abovementioned purposes. The energy cost for recompression of the carbon dioxide is considerable and should be minimized. The cost of removing absorption medium residues from the carbon dioxide should simultaneously also be minimized. This relates for example to minimizing the water consumption for the scrubbing out of the absorption medium residues from the carbon dioxide and thus minimizing the energy cost for the recovery (distillation) of the water used therefor and the scrubbed-out absorption medium. Another option is that of removing the absorption medium residues by adsorption onto an adsorption medium with subsequent desorption of the absorption medium residues from the adsorption medium. For such a process step too the energy cost should be minimized.

### SUMMARY

It is accordingly an object of the present invention to provide a process which minimizes the energy cost for recompression of the desorbed carbon dioxide.

It is a further object of the present invention to provide a process which minimizes the water consumption and thus the energy cost in respect of the recovery of water and absorption medium.

It is a further object of the present invention to provide a process which minimizes the energy cost in respect of an adsorption step for removal of absorption medium residues.

The independent claims make a contribution to the at least partial achievement of at least one of the above objects. The dependent claims provide preferred embodiments which contribute to the at least partial achievement of at least one of the objects. Preferred embodiments of constituents of one category according to the invention are, where relevant, likewise preferred for identically named or corresponding constituents of a respective other category according to the invention.

The terms “having”, “comprising” or “containing” etc. do not preclude the possible presence of further elements, ingredients etc. The indefinite article “a” does not preclude the possible presence of a plurality.

The objects of the invention are at least partially solved by a process for separating carbon dioxide (CO₂) from a raw hydrogen product stream, wherein the raw hydrogen product stream comprises at least hydrogen (H₂) and carbon dioxide, comprising the process steps of
a) removing carbon dioxide from the raw hydrogen product stream by absorption in an absorption medium in an absorption stage at absorption pressure to obtain a carbon dioxide-laden absorption medium stream and a hydrogen product stream and wherein the absorption pressure has an absorption pressure value pA;
b) removing the carbon dioxide-laden absorption medium stream and the hydrogen product stream from the absorption stage;
c) removing carbon dioxide from the laden absorption medium stream by desorption of the carbon dioxide from the laden absorption medium in a plurality of serially arranged decompression stages at desorption pressure, thus withdrawing a carbon dioxide substream from each of the decompression stages, and wherein each of the decompression stages has a desorption pressure with a desorption pressure value pD which is lower than the absorption pressure value pA and wherein the desorption pressure value pD decreases from decompression stage to decompression stage in the flow direction of the absorption medium;
d) compressing the carbon dioxide substreams withdrawn from the decompression stages in a plurality of serially arranged compression stages, wherein the carbon dioxide substreams are combined into a carbon dioxide total stream, thus affording a carbon dioxide total stream,
and wherein each of the compression stages has a suction pressure with a suction pressure value pS and the suction pressure value pS increases from compression stage to compression stage in the flow direction of the carbon dioxide stream;
characterized in that
each compression stage is assigned at least one decompression stage for desorption of carbon dioxide, with the result that the number of decompression stages for the desorption of carbon dioxide at least corresponds to the number of assigned compression stages, wherein the gas outlet of a decompression stage is fluidically connected to the suction side of a compression stage assigned thereto and wherein the suction pressure value pS of a compression stage corresponds to the desorption pressure value pD of a decompression stage assigned thereto and wherein
the carbon dioxide total stream is treated in an absorption medium removal apparatus arranged downstream of the compression stages and configured for removal of absorption medium residues from the carbon dioxide total stream to afford a carbon dioxide product stream.

One option for treating the desorbed carbon dioxide is that of initially combining the carbon dioxide substreams discharged from the decompression stages and subsequently freeing them of absorption medium residues in a gas scrubber. The carbon dioxide freed of absorption medium residues is then pre-compressed and subsequently supplied to a drying stage. The dried and pre-compressed carbon dioxide is subsequently compressed to the desired target pressure in one or more further compression stages.

In the context of the present invention it was found that this procedure does not lead to the desired results and is therefore in need of improvement.

According to the invention each compression stage for compression of carbon dioxide is assigned at least one decompression stage, wherein the suction side of a compression stage is fluidically connected to the gas outlet of the assigned decompression stage and the suction pressure of the respective compression stage corresponds to the desorption pressure of the respective decompression stage. In this context “corresponding” is to be understood as meaning that the respective suction pressure value pS and the desorption pressure value pD of the assigned decompression stage are identical or substantially identical. A person skilled in the art in this context will be aware that the suction pressure value pS and the desorption pressure value pD will generally not be completely identical in practice due to the possible occurrence for example of pressure drops between the gas outlet of a decompression stage and the suction side of a compression stage.

Each compression stage is assigned at least one decompression stage and the number of decompression stages for the desorption of carbon dioxide is at least equal to the number of assigned compression stages. The gas outlet of a decompression stage is fluidically connected to the suction side of an assigned compression stage. “Assigned” decompression stages in the context of the invention are decompression stages whose gas outlet is fluidically connected to the suction side of an assigned compression stage. Accordingly “assigned” compression stages in the context of the invention are compression stages whose suction side is connected to the gas outlet of one or more assigned decompression stages.

The carbon dioxide total stream compressed by the compression stages is treated for removal of absorption medium residues in an absorption medium removal apparatus. According to the invention the removal of the absorption medium residues is thus carried out only once the carbon dioxide substreams withdrawn from the decompression stages have been combined into a carbon dioxide total stream and compressed in a plurality of serially arranged compression stages.

The number of decompression stages present for the desorption of carbon dioxide is at least equal to the number of compression stages. If for example three compression stages are present at least three decompression stages for the desorption of carbon dioxide are provided. In one embodiment two or more decompression stages may be assigned to one compression stage. In this case the gas outlets of the relevant decompression stages are in each case fluidically connected to the suction side of the assigned compression stage.

It has been found that according to the invention savings are made at least in terms of the energy cost of the overall process, in terms of the energy cost of the carbon dioxide compression, in terms of the cooling water consumption and in terms of the thermal outlay (for example for the thermal separation of absorption medium and water). These savings are achieved in contradistinction to a process in which the carbon dioxide substreams from the decompression stages are combined and initially freed of absorption medium residues before recompression of the carbon dioxide is carried out.

The process is configured for separation of carbon dioxide (CO₂) from a raw hydrogen product stream. The raw hydrogen product stream comprises at least hydrogen (H₂) and carbon dioxide. In one embodiment the raw hydrogen product stream comprises at least hydrogen, carbon monoxide (CO) and carbon dioxide.

In one embodiment the raw hydrogen product stream is shifted synthesis gas, i.e. synthesis gas reacted in the context of a water gas shift reaction. Such a synthesis gas comprises hydrogen and carbon dioxide as main components and carbon monoxide unconverted in the course of the water gas shift reaction in a smaller proportion. Synthesis gas may be produced from fossil inputs for example by processes known to those skilled in the art. It is preferable when synthesis gas is obtained by steam reforming (SMR), autothermal reforming (ATR), partial oxidation (POx) or gas-heated reforming (GHR) of natural gas.

In a further embodiment the raw hydrogen product stream is unshifted synthesis gas which comprises hydrogen, carbon monoxide and carbon dioxide as the main components.

According to step a) of the process carbon dioxide is removed from the raw hydrogen product stream by absorption in an absorption medium in an absorption stage at absorption pressure. The absorption medium is preferably a physical absorption medium. The absorption pressure has an absorption pressure value pA which is markedly above ambient pressure. In one embodiment the absorption pressure has an absorption pressure value pA of 30 to 80 bar, preferably of 40 to 60 bar. In one embodiment the process comprises a plurality of absorption stages, for example when in addition to carbon dioxide other gas constituents, such as for example sulfur compounds, require removal from the raw hydrogen product stream. The absorption stage or the plurality of absorption stages may be integrated in an absorption column for example. In one embodiment the absorption medium is cooled to improve the absorption of the respective gas component in the absorption medium, in particular of carbon dioxide.

According to step b) the absorption medium stream laden with carbon dioxide is withdrawn from the absorption stage. The hydrogen product stream is further withdrawn from the absorption stage. The hydrogen product stream corresponds to the raw hydrogen product stream depleted in carbon dioxide by the absorption in step a). If the raw hydrogen product stream is shifted synthesis gas the hydrogen product stream comprises hydrogen as its main component. To obtain pure hydrogen such a hydrogen product stream may be subjected to a further purification in a subsequent step, for example by means of a membrane separation or an apparatus for pressure swing adsorption. If the raw hydrogen product stream is unshifted synthesis gas the hydrogen product stream comprises hydrogen and carbon monoxide as its main components. Irrespective of whether the raw hydrogen product stream is unshifted or shifted synthesis gas the hydrogen product stream may still contain up to 5% carbon dioxide according to one example.

According to step c) the carbon dioxide is removed from the laden absorption medium by decompression relative to absorption pressure, i.e. desorbed. This is effected in a plurality of serially arranged decompression stages at a corresponding desorption pressure which is in every case lower than the absorption pressure. Every decompression stage for desorption of carbon dioxide has, in respect of the desorption pressure, a corresponding desorption pressure value pD which is in every case lower than the absorption pressure value pA. The desorption pressure value pD decreases from decompression stage to decompression stage in the flow direction of the absorption medium, in particular in the flow direction of the laden absorption medium, in particular in the flow direction of the laden absorption medium with decreasing carbon dioxide concentration. Due to the plurality of decompression stages for desorption of carbon dioxide according to step c) a carbon dioxide substream is withdrawn from each of the decompression stages.

In one embodiment the absorption medium in the decompression stages is not heated for desorption of carbon dioxide. In this case the decompression stages are so-called flash stages. In one embodiment the absorption medium is heated, in particular heated to boiling, in at least one decompression stage. In this embodiment at least one decompression stage is a hot regeneration stage. In a hot regeneration stage the vapours of the absorption medium act as a stripping means in the respective decompression stage. In a preferred embodiment the absorption medium in the last of the serially arranged decompression stages is heated to boiling to completely regenerate the absorption medium in the last regeneration stage.

According to step c) depending on the arrangement either a partially regenerated or a fully regenerated absorption medium is obtained in a decompression stage and withdrawn from the respective decompression stage. Partially regenerated absorption medium is preferably supplied to the next of the serially arranged decompression stages for further desorption of carbon dioxide. Fully regenerated absorption medium is preferably recycled to the absorption stage according to step a) for renewed absorption of carbon dioxide in this absorption stage.

If the last of the serially arranged decompression stages is a hot regeneration stage the carbon dioxide substream withdrawn from this hot regeneration stage may be supplied to an upstream decompression stage, in particular a flash stage. The carbon dioxide substream withdrawn from the hot regeneration stage is then withdrawn from this flash stage with the carbon dioxide substream and subsequently supplied to the compression stage to which this flash stage is assigned. It is preferable when the carbon dioxide substream withdrawn from the hot regeneration stage is supplied to the decompression stage having a similar pressure to the hot regeneration stage so that no dedicated compressor is required for the compression of the carbon dioxide substream withdrawn from the hot regeneration stage.

In an alternative embodiment the carbon dioxide substream desorbed from the hot regeneration stage is supplied to a downstream compression stage to which the hot regeneration stage is assigned after cooling in a heat exchanger.

The hot regeneration stage preferably operates at a desorption pressure value pD of 1.3 to 3 bar.

According to step d) the carbon dioxide substreams withdrawn from the decompression stages are compressed in a plurality of serially arranged compression stages. The carbon dioxide substreams are combined into a carbon dioxide total stream which is especially supplied to the last of the serially arranged compression stages, with the result that a carbon dioxide total stream results on the pressure side of this last compression stage. This is a compressed carbon dioxide total stream which may optionally be further compressed in one or more post-compression stages, in particular before the carbon dioxide total stream is subsequently supplied to the absorption medium removal apparatus.

For example the first of the serially arranged compression stages of the carbon dioxide substream is supplied from the decompression stage having the lowest desorption pressure value pD. The second of the serially arranged compression stages is supplied with the carbon dioxide substream which exits the first compression stage on the pressure side. Simultaneously the second compression stage is supplied with the carbon dioxide substream from the decompression stage having the second lowest desorption pressure value pD and so on.

Each of the compression stages may include one or more compressors, wherein compressor types known to those skilled in the art, such as piston compressors, centrifugal compressors, turbo compressors or liquid ring compressors, are employed. The selection of the compressor type depends for example on the particular absolute pressure of the carbon dioxide substream or carbon dioxide total stream on the suction side of the respective compression stage.

In one embodiment a compression stage has a cooling stage for cooling the carbon dioxide substream or carbon dioxide total stream issuing from the respective compression stage arranged downstream of it.

Each of the compression stages has a suction pressure on the suction side with a suction pressure value pS. The suction pressure value pS increases from compression stage to compression stage in the flow direction of the carbon dioxide stream. Each compression stage is assigned at least one decompression stage, wherein the suction pressure value pS of a compression stage corresponds to the desorption pressure value pD of an assigned decompression stage. The gas outlet of a decompression stage and the suction side of an assigned compression stage with corresponding values for pS and pD are fluidically connected to one another.

One embodiment of the process is characterized in that the suction pressure value pS of a compression stage and the desorption pressure value pD of an assigned decompression stage have the same value with a maximum divergence of 25%, in particular the value of the desorption pressure value pD is at most 25% higher than the value of the assigned suction pressure value pS.

Preferably and in the context of the present embodiment the expression “the suction pressure value pS of a compression stage corresponds to the desorption pressure value pD of an assigned decompression stage” is to be understood as meaning that the suction pressure value pS of a compression stage and the desorption pressure value pD of an assigned decompression stage have the same value with a maximum divergence of 25%. Especially the suction pressure value pS of the compression stage and the desorption pressure value pD of the assigned decompression stage differ from one another by at most 25%, wherein the suction pressure value pS preferably serves as a reference value. In other words the desorption pressure value pD is at most 25% greater or smaller than the suction pressure value. In particular the value of the desorption pressure value pD is not more than 25% higher (greater) than the value of the assigned suction pressure value pS. The latter is due to the occurrence especially of pressure drops on the carbon dioxide side in the flow direction from a decompression stage to a compression stage. Accordingly the desorption pressure value pD of a decompression stage is preferably specified such that it is higher, in particular at most 25% higher, than the suction pressure value pS of the compression stage to which the respective decompression stage is assigned.

One embodiment of the process is characterized in that the number of decompression stages for the desorption of carbon dioxide corresponds to the number of assigned compression stages.

In this case each compression stage is assigned a single decompression stage.

In particular the number of decompression stages corresponds to the number of compression stages arranged upstream of the absorption medium removal apparatus. The absorption medium removal apparatus may have a further compression stage or two or more further compression stages arranged downstream of it to further compress the carbon dioxide product stream. The compression stages arranged downstream of the absorption medium removal apparatus may be referred to as post-compression stages. These are not assigned a decompression stage, i.e. there is no direct fluid connection between the gas outlet of a decompression stage and the suction side of such a post-compression stage.

One embodiment of the process is characterized in that the desorption pressure value pD of a decompression stage is specified on the basis of the suction pressure value pS of the compression stage to which the decompression stage is assigned.

The desorption pressure value pD of a decompression stage may be simply adjusted by regulation via a decompression valve through which the respective stream of laden absorption medium enters the decompression stage. The desorption pressure value results especially from the compression ratios established at the respective compression stages. These in turn result from the maximum allowable temperature of the respective carbon dioxide substream or carbon dioxide total stream on the pressure side of the respective compression stage.

One embodiment of the process is characterized in that no heating of the laden absorption medium is effected, in particular no heating to boiling point of the absorption medium is effected, in the decompression stages.

If possible, and in the event that the respective specification for the carbon dioxide product stream can be met, the process according to this embodiment is operated without the use of a hot regeneration stage as a decompression stage.

One embodiment of the process is characterized in that each of the compression stages has a compression ratio of 2.0 to 4.0, preferably a compression ratio of 2.5 to 3.5, more preferably of 2.6 to 3.3.

As mentioned above the compression ratio of a compression stage is determined by the maximum allowable (design) temperature of the compressor selected for the respective compression stage. What is decisive here is the exit temperature of the carbon dioxide substream or, in the case of the last of the serially arranged compression stages, of the carbon dioxide total stream on the pressure side of the respective compressor.

One embodiment of the process is characterized in that
the absorption medium removal apparatus comprises a gas scrubber, wherein the gas scrubber removes absorption medium residues from the carbon dioxide total stream using water and the absorption medium removal apparatus comprises a drying apparatus arranged downstream of the gas scrubber.

The use of a gas scrubber in combination with water as the scrubbing medium for removal of absorption medium residues is especially suitable when using hygroscopic absorption media, such as methanol. The gas scrubber may be a scrubbing column for example which has the compressed carbon dioxide total stream flowing through it from bottom to top and in which water is run from top to bottom in countercurrent. The carbon dioxide total stream freed of absorption medium residues issuing from the column top is subsequently freed of water residues in a downstream drying apparatus. In one example the drying apparatus has an adsorbent for selective removal of water, for example a molecular sieve.

When using methanol as an absorption medium one embodiment of the process is characterized in that a methanol-water mixture is obtained in the gas scrubber which is withdrawn from the gas scrubber and subsequently
recycled to the absorption stage or
supplied to a thermal separation apparatus for thermal separation of the mixture into methanol and water and methanol withdrawn from the thermal separation apparatus is recycled to the absorption stage.

One embodiment of the process is characterized in that the absorption medium removal apparatus comprises an adsorption medium bed, wherein the removal of the absorption medium residues from the carbon dioxide total stream is effected through adsorption to the adsorption medium of the adsorption medium bed.

Desorption of the absorption medium residues from the adsorption medium may be effected by processes known to those skilled in the art.

This alternative may be suitable when absorption medium residues are removable with water in a gas scrubber only with difficulty, for example due to hydrophobic properties of the absorption medium or due to poor solubility of the absorption medium in water or miscibility with water.

One embodiment of the process is characterized in that
the process comprises three decompression stages for desorption of carbon dioxide from the laden absorption medium stream.

It is preferable when the three decompression stages in the flow direction of the laden absorption medium are a low pressure flash stage (low pressure (LP) flash), a low low pressure flash stage (low low pressure (LLP) flash) and a vacuum flash stage (vacuum flash (VF)). The low pressure flash stage preferably has a pressure range from 6 to 2.5 bar. The low low pressure flash stage preferably has a pressure range from 2.5 to 1.1 bar. It is preferable when the vacuum flash stage has a pressure of less than 1.1 bar, wherein an absolute pressure of up to 0.1 bar is achievable.

Accordingly one embodiment of the process is characterized in that the desorption pressure values pD of the decompression stages utilized for the desorption of carbon dioxide are in a range from 0.1 to 6 bar, preferably in a range from 0.4 to 3.0 bar.

One embodiment of the process is characterized in that
the plurality of decompression stages for desorption of carbon dioxide have arranged upstream of them a further decompression stage for desorption of at least hydrogen from the laden absorption medium, thus affording a hydrogen recycle stream which is withdrawn from the decompression stage for desorption of hydrogen and wherein the hydrogen recycle stream is supplied to the raw hydrogen product stream. The hydrogen recycle stream may alternatively be sent as fuel to an upstream process for producing the raw hydrogen product stream. Examples include the supply of fuel to the burners in the radiation zone of a steam reformer or to the burner of an autothermal reformer. In one embodiment the hydrogen recycle stream contains not only hydrogen but also carbon monoxide.

In the context of the invention a distinction is to be made between decompression stages for desorption of carbon dioxide and decompression stages for desorption of valuable gases, in particular hydrogen. Hydrogen exhibits a lower coefficient of absorption than carbon dioxide having regard to the especially employed physical absorption media, in particular methanol. Nevertheless, it is always a non-negligible amount of hydrogen that is co-absorbed in the absorption step according to step a). This co-absorbed hydrogen may be desorbed from the absorption medium at relatively high pressures in a pressure range in which carbon dioxide remains absorbed in the absorption medium. The same applies to carbon monoxide when using unshifted synthesis gas as raw hydrogen product stream. Accordingly the decompression stage for desorption of at least hydrogen is arranged upstream of the decompression stages for desorption of carbon dioxide. The decompression stage for desorption of at least hydrogen is preferably operated in a pressure range of 9 to 25 bar.

One embodiment of the process is characterized in that the absorption medium removal apparatus has a further compression stage for compression of the carbon dioxide product stream arranged downstream of it.

Depending on the requirement, in particular for CCS applications, it may be necessary to further compress the carbon dioxide product stream. For gaseous carbon dioxide an absolute pressure of 20 bar may be sufficient while for the liquefied, supercritical carbon dioxide still higher pressures are required.

The absorption medium is especially a physical absorption medium.

One embodiment of the process is characterized in that the absorption medium comprises methanol, in particular consists of methanol. It is preferable when the absorption of the carbon dioxide according to step a) employs cryogenic methanol which is used in a temperature range between −30° C. (minus 30 degrees Celsius) and −70° C. (minus 70 degrees Celsius).

In a further embodiment the absorption medium is a mixture of dimethyl ethers of polyethylene glycols.

In a further embodiment the absorption medium is a chemical absorption medium.

It is preferable when the chemical absorption medium contains an amine or a mixture of amines or consists of an amine or a mixture of amines. Such an absorption process is also referred to as an amine scrubbing and is known to those skilled in the art. The absorption medium may contain an amine, such as monoethanolamine (MEA), diethanolamine (DEA), methyldiethanolamine (MDEA), diglycolamine (DGA), aminomethylpropanol (AMP), a promoter, such as piperazine (PZ), or a mixture of at least one of the aforementioned.

One embodiment of the process is characterized in that a post-compression stage is arranged downstream of the plurality of serially arranged compression stages and upstream of the absorption medium removal apparatus, wherein the post-compression stage is fluidically connected to the last of the serially arranged compression stages and to the absorption medium removal apparatus.

The post-compression stage differs from the compression stages in that it is not fluidically connected to the gas outlet of a decompression stage via its suction side. By contrast, the post-compression stage is in particular directly fluidically connected to the last of the serially arranged compression stages. In one embodiment two or more post-compression stages are arranged downstream of the plurality of serially arranged compression stages and upstream of the absorption medium removal apparatus. These are preferably serially arranged.

One embodiment of the process is characterized in that an intermediate compression stage is arranged between two of the plurality of serially arranged compression stages, wherein the intermediate compression stage is fluidically connected to the compression stage arranged upstream of it and to the compression stage arranged downstream of it.

The intermediate compression stage differs from the compression stages in that it is not fluidically connected to the gas outlet of a decompression stage via its suction side. By contrast the intermediate compression stage is especially directly fluidically connected to the respective upstream compression stage and the respective downstream compression stage and/or to at least one further intermediate compression stage.

### BRIEF DESCRIPTION OF THE DRAWINGS

In the examples which follow the invention will now be more particularly elucidated with reference to the figures. The inventive exemplary embodiment represents an exemplary configuration of the invention without any scope-limiting effect.

In the Figures:

FIG. 1 shows a simplified process flow diagram of a process 100 according to an inventive example and

FIG. 2 shows a simplified process flow diagram of a process 200 according to a comparative example.

### DETAILED DESCRIPTION OF THE PREFERRED EMBODIMENTS

In the figures identical elements are provided with identical reference numerals. Gas streams are shown as dashed lines while liquid streams are shown as solid lines. It will be appreciated that gas streams may also contain liquid and liquids may contain gases, for example in dissolved form. Arrow tips indicate the flow direction of the particular stream. The absorption medium is methanol.

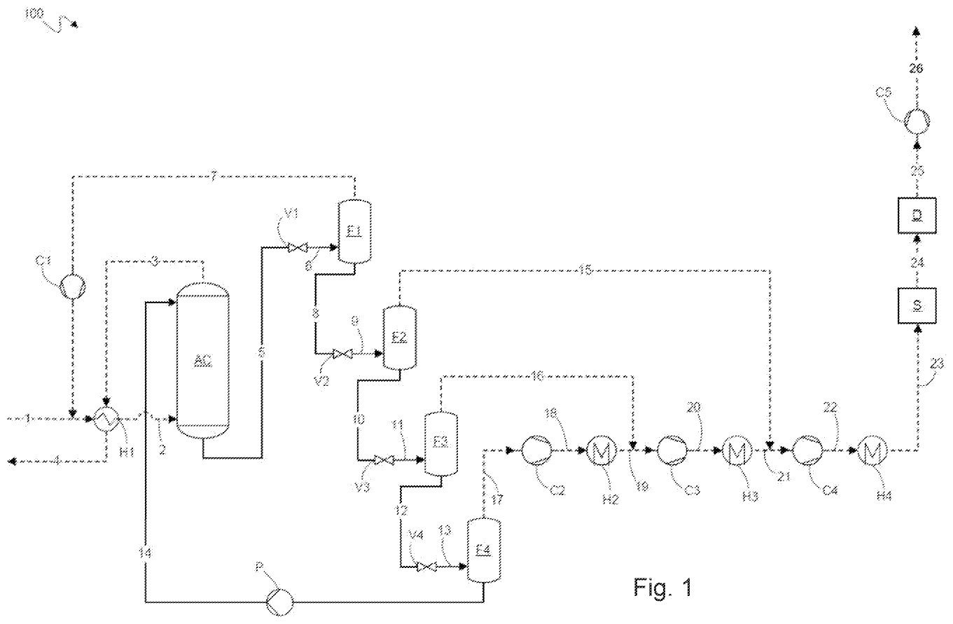

FIG. 1 shows a simplified process flow diagram 100 of a process according to the invention for separating carbon dioxide (CO₂) from a raw hydrogen product stream to obtain a hydrogen product stream and a carbon dioxide product stream.

Conduit 1 supplies a raw hydrogen product stream which has been produced for example by water gas shift of a synthesis gas from a steam reformer (not shown). The raw hydrogen product stream contains hydrogen as target product and carbon dioxide as by-product to be removed. In addition to the main components hydrogen and carbon dioxide the raw hydrogen product stream may further contain small concentrations of gas constituents such as carbon monoxide and methane and also water. The raw hydrogen product stream could also be unshifted synthesis gas. In this case the target product would be synthesis gas, i.e. a mixture of predominantly hydrogen and carbon monoxide.

The raw hydrogen product stream is initially precooled in heat exchanger H1 to a temperature of about −15° C., subsequently sent on via conduit 2 and finally introduced into an absorption column AC which is provided as an absorption stage for the absorption of carbon dioxide from the raw hydrogen product stream. The absorption column AC is at an absorption pressure of about 40 bar which corresponds to the absorption pressure value pA. For absorption of the carbon dioxide in methanol the raw hydrogen product stream in the bottom region is introduced into the absorption column AC and flows from bottom to top therein. Simultaneously, regenerated methanol is introduced into the absorption column AC via conduit 27 in the top region of said column and accordingly flows therein from top to bottom. Before the regenerated methanol is introduced into the absorption column AC it is cooled to a cryogenic temperature of down to −70° C. (cooling means not shown).

In the absorption column AC a methanol stream (absorption medium stream) laden with mainly carbon dioxide and a carbon dioxide-poor hydrogen product stream are obtained. The hydrogen product stream is withdrawn from the absorption column AC via conduit 3 and used in heat exchanger H1 to cool the raw hydrogen product stream. The hydrogen product stream thus heated is sent on via conduit 4, discharged from the process and sent for further processing. For example the hydrogen product stream may be supplied to a pressure swing adsorption apparatus (PSA unit) to produce pure hydrogen from the hydrogen product stream.

The methanol stream withdrawn from absorption column AC and laden with carbon dioxide is sent on via conduit 5 and decompressed to a pressure of 12 bar using the decompression valve V1. The decompressed methanol stream is sent on via conduit 6 and introduced into a flash vessel F1. The flash vessel F1 represents a decompression stage which is configured for desorption of valuable gas co-absorbed in the absorption medium. In the case of the process 100 this valuable gas is mainly hydrogen.

If the raw hydrogen product stream were unshifted synthesis gas at this point predominantly a mixture of hydrogen and carbon monoxide would be obtained as flash gas in the flash vessel F1.

The hydrogen stream obtained in the flash vessel F1 as flash gas is withdrawn from the flash vessel F1 via conduit 7 and recompressed to absorption pressure using compressor C1. The recompressed hydrogen stream is subsequently supplied to the raw hydrogen product stream in conduit 1 and is thus recycled into the process for renewed treatment in absorption column AC.

The methanol laden mainly with carbon dioxide and free from co-absorbed valuable gas is withdrawn from flash vessel F1 via conduit 8 and decompressed to a pressure of 3.0 bar using the decompression valve V2. The flash vessel F2 is at desorption pressure with a desorption pressure value pD of 3.0 bar. The decompressed absorption medium is subsequently introduced into the flash vessel F2 via conduit 9. Flash vessel F2 is the first of three decompression stages for desorption of carbon dioxide from the laden methanol. Flash vessel F2 is a low pressure flash stage. A carbon dioxide substream is passed from the flash vessel F2 to the suction side of the compressor C4 via conduit 15 and conduit 21. As a result, the gas outlet (not shown) of the flash vessel F2 is fluidically connected to the suction side of the compressor C4. Compressor C4 represents the third of three compression stages configured for compression of carbon dioxide which are arranged upstream of the absorption medium removal apparatus. Compressor C4 compresses the carbon dioxide total stream from conduits 21 and 15 from 2.8 bar on the suction side of the compressor C4 to 7.6 bar on the pressure side of the compressor C4. The carbon dioxide total stream is sent on via conduit 22 and subsequently cooled in heat exchanger H4. Upon exiting the heat exchanger H4 the carbon dioxide total stream has a pressure of 7.5 bar.

The absorption medium which is still partially laden with carbon dioxide is further withdrawn from the flash vessel F2 via conduit 10, decompressed to 1.3 bar in the decompression valve V3 and introduced into the flash vessel F3 via conduit 11. Flash vessel F3 is the second of three decompression stages for desorption of carbon dioxide from the laden methanol. Flash vessel F3 is a low low pressure flash stage. A carbon dioxide substream is passed from the flash vessel F3 to the suction side of the compressor C3 via conduit 16 and conduit 19. As a result, the gas outlet (not shown) of the flash vessel F3 is fluidically connected to the suction side of the compressor C3. Compressor C3 represents the second of three compression stages configured for compression of carbon dioxide which are arranged upstream of the absorption medium removal apparatus. Compressor C3 compresses a carbon dioxide substream from conduits 16 and 19 from 1.1 bar on the suction side of the compressor C3 to 2.9 bar on the pressure side of the compressor C3. The carbon dioxide substream is sent on via conduit 20 and subsequently cooled in heat exchanger H3. Upon exiting the heat exchanger H3 the carbon dioxide substream has a pressure of 2.8 bar.

The absorption medium which remains partially laden with carbon dioxide is further withdrawn from the flash vessel F3 via conduit 12, decompressed to 0.4 bar in the decompression valve V4 and introduced into the flash vessel F4 via conduit 13. Flash vessel F4 is the third of three decompression stages for desorption of carbon dioxide from the laden methanol. Flash vessel F4 is a vacuum flash stage. A carbon dioxide substream is passed from the flash vessel F4 to the suction side of the compressor C2 via conduit 17. As a result, the gas outlet (not shown) of the flash vessel F4 is fluidically connected to the suction side of the compressor C2. Compressor C2 represents the first of three compression stages configured for compression of carbon dioxide which are arranged upstream of the absorption medium removal apparatus. Compressor C2 compresses a carbon dioxide substream from conduit 17 from 0.4 bar on the suction side of the compressor C2 to 1.1 bar on the pressure side of the compressor C2. The carbon dioxide substream is sent on via conduit 18 and subsequently cooled in heat exchanger H2. Upon exiting the heat exchanger H2 the carbon dioxide substream has a pressure of 1.1 bar.

From the flash vessel F4 a methanol stream largely freed of carbon dioxide is withdrawn via conduit 14, recompressed to the absorption pressure of about 40 bar by pump P and supplied to absorption column AC via the top region thereof.

The methanol stream withdrawn from the flash vessel F4 may optionally (not shown) be supplied to a further decompression stage configured as a hot regeneration stage. This makes it possible to further increase the amount of recovered (desorbed) carbon dioxide and/or increase the efficiency of the absorption medium through improved regeneration.

According to the invention compressor C2, i.e. the first compression stage, is assigned flash vessel F4, i.e. the third decompression stage configured for the desorption of carbon dioxide. At 0.4 bar, the desorption pressure value pD in the third decompression stage (flash vessel F4) corresponds to the suction pressure value pS of the first compression stage (compressor C2) which is likewise 0.4 bar.

Furthermore, compressor C3, i.e. the second compression stage, is assigned flash vessel F3, i.e. the second decompression stage configured for the desorption of carbon dioxide. At 1.3 bar, the desorption pressure value pD in the second decompression stage (flash vessel F3) corresponds for the purposes of the invention to the suction pressure value pS of the second compression stage (compressor C3) which is 1.1 bar. The divergence of 0.2 bar of the desorption pressure value corresponds to a difference of about 18% relative to the suction pressure value pS selected as a reference.

Furthermore, compressor C4, i.e. the third compression stage, is assigned flash vessel F2, i.e. the first decompression stage configured for the desorption of carbon dioxide. At 3.0 bar, the desorption pressure value pD in the first decompression stage (flash vessel F2) corresponds to the suction pressure value pS of the second compression stage (compressor C3) which is 2.8 bar. The divergence of 0.2 bar of the desorption pressure value corresponds to a difference of about 7% relative to the suction pressure value pS selected as a reference.

On account of the configuration according to the invention the carbon dioxide substreams from conduits 15, 16 and 17 are combined into a compressed carbon dioxide total stream which after cooling in heat exchanger H4 is sent on via conduit 23 and supplied to an absorption medium removal apparatus. The absorption medium removal apparatus comprises as components at least one scrubber S (gas scrubber) and a drying apparatus D. The scrubber S is configured for example as a scrubbing column in which methanol residues are scrubbed out of the compressed carbon dioxide total stream using water as scrubbing medium in countercurrent. The methanol-water mixture which results as scrubbing liquid may subsequently be separated into its constituents by distillation in a rectification column for reuse as absorption medium and scrubbing medium (not shown). A rectification column (not shown) is typically part of the process since water continuously entrained by the raw hydrogen product requires removal from the absorption medium circuit.

The carbon dioxide total stream largely freed of absorption medium residues is withdrawn from the scrubber S and supplied via conduit 24 to the drying apparatus D. The carbon dioxide total stream treated in scrubber S still contains residues of water which are removed in the drying apparatus D. The drying apparatus D comprises for example a bed of an adsorbent which binds water and is regenerable. The adsorbent may be a zeolite-based molecular sieve for example.

The dried carbon dioxide total stream freed of absorption medium residues is withdrawn from the drying apparatus D via conduit 25 as carbon dioxide product stream. In a last process step the carbon dioxide total stream is compressed to a final pressure of 20.3 bar in a compressor C5 and optionally cooled again (not shown), thus affording a further compressed carbon dioxide product stream which is suitable for example for subterranean storage (sequestration).

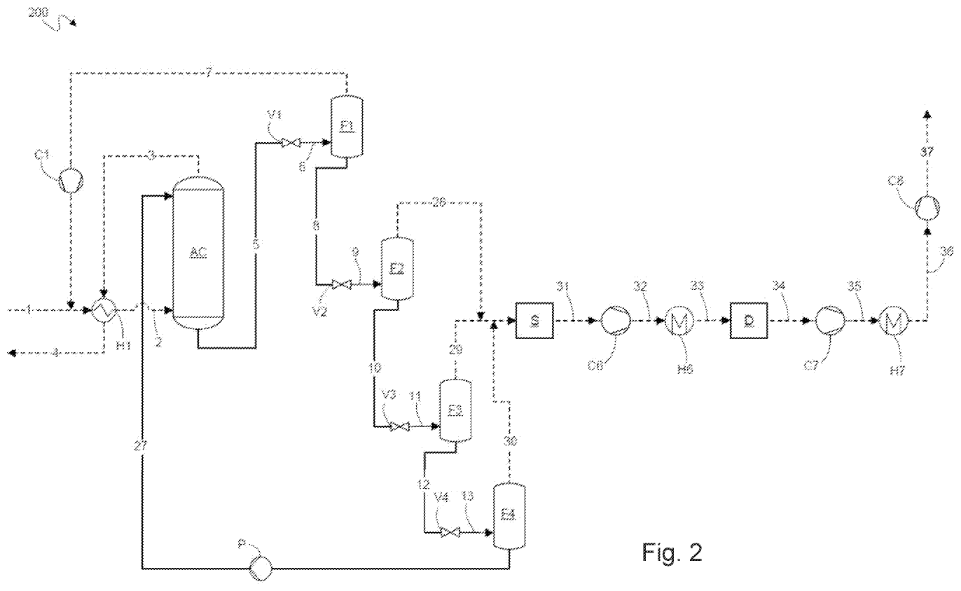

FIG. 2 shows a simplified process flow diagram 200 of a process for separating carbon dioxide (CO₂) from a raw hydrogen product stream according to a non-inventive comparative example.

Similarly to process 100, process 200 comprises an arrangement of an absorption column AC and four flash vessels whose interconnection and function on the side of the absorption medium (methanol) substantially corresponds to process 100.

However, before compression according to process 200 the carbon dioxide substreams withdrawn from flash vessels F2, F3 and F4 are combined into an (uncompressed) carbon dioxide total stream which is sent to a scrubber S for removal of absorption medium residues. Scrubber S is configured similarly to the scrubber of process 100 but is operated at substantially lower pressure. The carbon dioxide total stream largely freed of absorption medium (methanol) is withdrawn from the scrubber S via conduit 31, pre-compressed in compressor C6, sent on via conduit 32 and cooled in heat exchanger H6. The carbon dioxide total stream is subsequently supplied via conduit 33 to a drying apparatus D which is configured similarly to the drying apparatus D according to process 100. The carbon dioxide total stream freed of absorption medium and dried is subsequently sent on via conduit 34 and further compressed in compressor C7. The further compressed carbon dioxide total stream is further sent on via conduit 35, cooled in heat exchanger H7 and sent via conduit 36 to a last compressor for compressing to a final pressure of about 20 bar. This affords a compressed carbon dioxide product stream which is suitable for example for subterranean storage (sequestration).

The following table is based on simulation data and shows the inventive advantages of the process according to FIG. 1 compared to a comparative example represented by FIG. 2. The production of 500 kNm³ of hydrogen per hour is used as a basis, the synthesis gas being produced from natural gas by an ATR reactor and subsequently shifted.

| | | | Comparative | Example |
|---|---|---|---|---|
| | | | example | Invention |
| Line | Parameters | Unit | (FIG. 2) | (FIG. 1) |
| 1 | Total gas scrubbing power | MW | 5.4 | 5.3 |
| | (absorption and flash vessel | | | |
| | without cooling absorption | | | |
| | medium) | | | |
| 2 | Electrical refrigeration | MW | 7.7 | 7.7 |
| 3 | Electricity for CO₂ | MW | 26.9 | 22.6 |
| | compressors | | | |
| 4 | Total power | MW | 40 | 36 |
| 5 | Total cooling water | t/h | 2100 | 1800 |
| 6 | Thermal energy | MW | 13 | 12.5 |
| 7 | Methanol in carbon dioxide | ppmv | 160 | 170 |
| | product stream | | | |
| 8 | Fresh water for scrubber S | kmol/h | 350 | 150 |

The simulation data show that savings in respect of the electrical power to be used for the compressors (line 3) are achieved in particular. This considerably reduces the total power, in particular electrical energy, to be used for the process (line 4). Furthermore, the removal of the absorption medium residues in the scrubber S requires a considerably smaller amount of fresh water (line 8) without a significant reduction in the quality of the carbon dioxide product stream in respect of the methanol concentration remaining in the carbon dioxide product (line 7). The smaller amount of fresh water required for scrubbing out methanol means that the amount of thermal energy required is also smaller (line 6). This is required for example for separating the methanol-water mixture produced in the scrubber S, for example in the boiling of the mixture in the bottom region of a rectification column in which the pure components methanol and water are recovered. A small amount of cooling water (line 5) is also required. Cooling water is especially needed for the cooling of the carbon dioxide streams before these can be introduced into a subsequent compression stage.

### LIST OF REFERENCE SYMBOLS

100 Process (invention)
200 Process (comparative example)
1-37 Conduit
AC Absorption column (absorption stage)
C1-C8 Compressors
F1-F4 Flash vessels (decompression stages)
H1-H7 Heat exchanger
V1-V4 Decompression valves
S Scrubber
D Drying apparatus
P Pump

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A process for separating carbon dioxide from a raw hydrogen product stream, wherein the raw hydrogen product stream comprises at least hydrogen and carbon dioxide, comprising the process steps of
a) removing carbon dioxide from the raw hydrogen product stream by absorption in an absorption medium in an absorption stage at absorption pressure to obtain a carbon dioxide-laden absorption medium stream and a hydrogen product stream and wherein the absorption pressure has an absorption pressure value pA;
b) removing the carbon dioxide-laden absorption medium stream and the hydrogen product stream from the absorption stage;
c) removing carbon dioxide from the laden absorption medium stream by desorption of the carbon dioxide from the laden absorption medium in a plurality of serially arranged decompression stages at desorption pressure, thus withdrawing a carbon dioxide substream from each of the decompression stages, and wherein each of the decompression stages has a desorption pressure with a desorption pressure value pD which is lower than the absorption pressure value pA and wherein the desorption pressure value pD decreases from decompression stage to decompression stage in the flow direction of the absorption medium;
d) compressing the carbon dioxide substreams withdrawn from the decompression stages in a plurality of serially arranged compression stages, wherein the carbon dioxide substreams are combined into a carbon dioxide total stream, thus affording a carbon dioxide total stream,
and wherein each of the compression stages has a suction pressure with a suction pressure value pS and the suction pressure value pS increases from compression stage to compression stage in the flow direction of the carbon dioxide stream;
wherein each compression stage is assigned at least one decompression stage for desorption of carbon dioxide, with the result that the number of decompression stages for the desorption of carbon dioxide at least corresponds to the number of assigned compression stages, wherein the gas outlet of a decompression stage is fluidically connected to the suction side of a compression stage assigned thereto and wherein the suction pressure value pS of a compression stage corresponds to the desorption pressure value pD of a decompression stage assigned thereto and wherein
the carbon dioxide total stream is treated in an absorption medium removal apparatus arranged downstream of the compression stages and configured for removal of absorption medium residues from the carbon dioxide total stream to afford a carbon dioxide product stream.

2. The process according to claim 1, wherein the suction pressure value pS of a compression stage and the desorption pressure value pD of an assigned decompression stage have the same value with a maximum divergence of 25%.

3. The process according to claim 1, wherein the number of decompression stages for the desorption of carbon dioxide corresponds to the number of assigned compression stages.

4. The process according to claim 1, wherein the desorption pressure value pD of a decompression stage is specified on the basis of the suction pressure value pS of the compression stage to which the decompression stage is assigned.

5. The process according claim 1, wherein no heating of the laden absorption medium is effected in the decompression stages.

6. The process according to claim 1, wherein each of the compression stages has a compression ratio of 2.0 to 4.0.

7. The process according to claim 1, wherein the absorption medium removal apparatus comprises a gas scrubber, wherein the gas scrubber removes absorption medium residues from the carbon dioxide total stream using water and the absorption medium removal apparatus comprises a drying apparatus arranged downstream of the gas scrubber.

8. The process according to claim 7, wherein a methanol-water mixture is obtained in the gas scrubber which is withdrawn from the gas scrubber and subsequently
recycled to the absorption stage or
supplied to a thermal separation apparatus for thermal separation of the mixture into methanol and water and methanol withdrawn from the thermal separation apparatus is recycled to the absorption stage.

9. The process according to claim 1, wherein the absorption medium removal apparatus comprises an adsorption medium bed, wherein the removal of the absorption medium residues from the carbon dioxide total stream is effected through adsorption to the adsorption medium of the adsorption medium bed.

10. The process according to claim 1, wherein the process comprises three decompression stages for desorption of carbon dioxide from the laden absorption medium stream.

11. The process according to claim 1, wherein the desorption pressure values pD of the decompression stages utilized for the desorption of carbon dioxide are in a range from 0.1 to 6 bar.

12. The process according to claim 1, wherein the plurality of decompression stages for desorption of carbon dioxide have arranged upstream of them a further decompression stage for desorption of at least hydrogen from the laden absorption medium, thus affording a hydrogen recycle stream which is withdrawn from the decompression stage for desorption of hydrogen and wherein the hydrogen recycle stream is supplied to the raw hydrogen product stream.

13. The process according to claim 1, wherein the absorption medium removal apparatus has a further compression stage for compression of the carbon dioxide product stream arranged downstream of it.

14. The process according to claim 1, wherein the absorption medium comprises methanol.

15. The process according to claim 1, wherein a post-compression stage is arranged downstream of the plurality of serially arranged compression stages and upstream of the absorption medium removal apparatus, wherein the post-compression stage is fluidically connected to the last of the serially arranged compression stages and to the absorption medium removal apparatus.

16. The process according to claim 1, wherein an intermediate compression stage is arranged between two of the plurality of serially arranged compression stages, wherein the intermediate compression stage is fluidically connected to the compression stage arranged upstream of it and to the compression stage arranged downstream of it.
